(19) United States
(12) Patent Application Publication
(10) Pub. No.: US 2016/0019473 A1
(43) Pub. Date: Jan. 21, 2016

(54) ARRANGING TRANSPORT AMONGST PARTIES THROUGH USE OF MOBILE DEVICES

(71) Applicant: OtiTopic Inc., Los Angeles, CA (US)

(72) Inventor: Kambiz YADIDI, Los Angeles, CA (US)

(21) Appl. No.: 14/490,530

(22) Filed: Sep. 18, 2014

Related U.S. Application Data
(60) Provisional application No. 62/026,481, filed on Jul. 18, 2014.

(51) Int. Cl. G06Q 10/02; G06Q 40/08; G06Q 50/22

(52) U.S. Cl. CPC G06Q 10/02; G06Q 50/22; G06Q 40/08

(57) ABSTRACT

Arranging transport among parties by mobile devices can involve receiving a user request for transportation via an application programming interface installed in a user mobile device and providing user data to a transport provider, the user data including healthcare insurance credentials for the user. Arranging transport may also include verifying the healthcare insurance credentials with an insurance provider, determining a user location based on a global positioning system (GPS) circuit in the user mobile device, and selecting a responder from a plurality of responders, the responder having a handicap accessible vehicle for non-emergency transportation. Arranging transport can also include tracking the responder via a GPS circuit in a responder mobile device, requesting a user rating when the responder has transported the user to a desired location, and ranking the user and the responder based at least on the user rating.

### CROSS-REFERENCE TO RELATED APPLICATIONS

This application claims priority to U.S. Prov. Pat. App. No. 62/026,481, entitled ARRANGING TRANSPORT AMONG PARTIES THROUGH USE OF MOBILE DEVICES, filed on Jul. 18, 2014, the contents of which are hereby incorporated by reference in their entirety for all purposes.

### BACKGROUND

Embodiments described herein are generally related to the field of systems and methods for arranging transport among parties by mobile devices. More particularly, embodiments disclosed herein are related to arranging non-emergency medical transportation for people to and from a residence area, a nursing home, a hospital, clinic, pharmacy, and other temporary or permanent locations.

### SUMMARY

Current systems for private transportation of people involve communication mechanisms that leave the client out of the information loop. Moreover, traditional systems often require the client to remain at a fixed location while a vehicle is dispatched for service. Also, payment of transportation fees in traditional systems involves the exchange of cash or credit information between the client and the driver. These inconveniences become more acute in non-emergency medical transportation services. Currently, non-emergency medical transportation strategies make use of emergency vehicles such as ambulances, excessively rising the cost of the transportation process in the case of non-emergency situations. Some approaches to provide lower cost non-emergency medical transportation include systems that provide a direct service between a given patient and a given responder. Such systems result in long waiting times for the patient, inconveniently reducing overall time efficiency of the transportation process. Moreover, in many instances patients are required to contract the transportation services well in advance of the actual transportation process. For example, in many instances patients request the service one day or at least several hours in advance of the transportation process to ensure availability of service. This adds a logistic burden to patients that may have diminished capacity due to their medical condition.

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1, clause 9, clause 18, clause 23 or clause 26. The other clauses can be presented in a similar manner.

### Clause 1

A system including:
a network interface configured to receive a user request for transportation and to provide user data to a transport provider;
a dispatcher configured to provide the request for transportation to a plurality of responders;
a processor configured to verify insurance information for the user and to select a responder from the plurality of responders;
a tracker circuit configured to determine a user location and a responder location;
a graphics circuit configured to provide a street map indicating a current user location and a current responder location to the user and to the responder; and
a memory coupled to:
   a user account database comprising personal user information for a plurality of users;
   a ratings database configured to store a user rating; and
   a transaction log configured to store events in the transportation process.

### Clause 2

The system of clause 1, wherein the processor is further configured to rank the user and the responder.

### Clause 3

The system as in clause 1, wherein the network interface is further configured to provide a progress report to the user, the progress report including the street map provided by the graphics circuit.

### Clause 4

The system as in clause 1, further comprising a fee calculator circuit to determine a fee to cover at least partially a cost of transportation, and wherein the network interface is further configured to provide the fee to at least one of a transport provider, an insurance provider, and the user.

### Clause 5

The system as in clause 4, further configured to receive payment of at least a portion of the fee from the transport provider, conditional upon issuance of an authorization from the insurance provider.

### Clause 6

The system as in clause 4, wherein the fee calculator is configured to provide a flat referral fee to the transport provider.

### Clause 7

The system of clause 1, wherein the ratings database is further configured to store a responder rating.

### Clause 8

The system of clause 1, wherein the ratings database stores historical information of each of the plurality of responders.

### Clause 9

A method for arranging transport among parties by mobile devices, the method comprising:
receiving a user request for transportation via an application programming interface installed in a user mobile device;
providing a user data to a transport provider, the user data comprising healthcare insurance credentials for the user;
verifying the healthcare insurance credentials with an insurance provider;
determining a user location based on a global positioning system (GPS) circuit in the user mobile device;
selecting a responder from a plurality of responders, the responder having a handicap accessible vehicle for non-emergency transportation;
tracking the responder via a GPS circuit in a responder mobile device;
requesting a user rating when the responder has transported the user to a desired location; and ranking the user and the responder based at least on the user rating.

### Clause 10

The method of clause 9, wherein selecting a responder from a plurality of responders comprises sending a transport request signal to a responder located closest to the user.

### Clause 11

The method of clause 9, wherein selecting a responder from a plurality of responders comprises sending a transport request signal to a responder that is authorized by an insurance provider.

### Clause 12

The method of clause 9, further comprising determining a fee for the transport.

### Clause 13

The method of clause 12, further comprising providing the fee to the transport provider.

### Clause 14

The method of clause 12, further comprising providing the fee to an insurance provider.

### Clause 15

The method of clause 12, further comprising receiving a fund covering the fee at least partially, from the transport provider.

### Clause 16

The method of clause 9, further comprising providing a list comprising a plurality of patients to the user, and receiving a selection from the user of a patient to be transported, from the plurality of patients.

### Clause 17

The method of clause 9, wherein verifying the healthcare insurance credentials with an insurance provider comprises contacting a primary insurance provider, and a secondary insurance provider when the primary insurance provider refuses payment.

### Clause 18

A non-transitory computer readable medium storing commands which, when executed by a processor circuit in a server cause the server to perform a method comprising:
receiving a user request for transportation via an application programming interface installed in a user mobile device;
providing user data to a transport provider, the user data comprising healthcare insurance credentials for the user;
verifying the healthcare insurance credentials with an insurance provider;
determining a user location based on a global positioning system (GPS) circuit in the user mobile device;
selecting a responder from a plurality of responders, the responder having a handicap accessible vehicle for non-emergency transportation;
tracking the responder via a GPS circuit in a responder mobile device;
requesting a user rating when the responder has transported the user to a desired location; and
ranking the user and the responder based at least on the user rating.

### Clause 19

The non-transitory computer readable medium of clause 18, wherein verifying the healthcare insurance credentials comprises receiving from the insurance provider an authorization to proceed with the transportation process for the user.

### Clause 20

The non-transitory computer readable medium of clause 18, further comprising commands to cause the server to perform providing a progress report to the user indicating a location of the selected responder and an updated estimated time of arrival for pickup.

### Clause 21

The non-transitory computer readable medium of clause 18, wherein providing user data to a transport provider comprises providing user data to a plurality of transport providers, each of the plurality of transport providers controlling a set of responders.

### Clause 22

The non-transitory computer readable medium of clause 18, further comprising commands to cause the server to perform storing the user rating in a ratings database coupled to the non-transitory computer readable medium.

### Clause 23

A method, comprising:
receiving a registration request from a user;
receiving insurance information from the user, the insurance information comprising a primary insurer and a secondary insurer;
receiving health information from the user;
providing a payment option for arranging a non-emergency medical transportation for the user, the payment options comprising out-of-pocket payment options; and
verifying that at least one of the primary insurer or the secondary insurer covers the user for a transportation service according to the health information received from the user.

### Clause 24

The method of clause 23, further comprising adding the user to a list of users associated with a registration account.

### Clause 25

The method of clause 24, further comprising registering the registration account to a care giver in a healthcare facility.

### Clause 26

A method for arranging transport among parties by mobile devices, the method comprising:
receiving a user request for transportation via an application programming interface installed in a user mobile device;
receiving information about the user medical condition;
providing a user data to a transport provider, the user data comprising healthcare insurance credentials for the user;
verifying the healthcare insurance credentials with an insurance provider;
determining a user location based on a global positioning system (GPS) circuit in the user mobile device;
ranking responders according to the user medical condition;
receive a selection of at least one responder from the user based in the responder ranking; and
instructing the transport provider to direct the selected responder to provide transport to the user.

### BRIEF DESCRIPTION OF THE DRAWINGS

FIG. 1A illustrates a system for arranging transport between parties, according to some embodiments.

FIG. 1B illustrates a vehicle used by a responder in a system for between parties, according to some embodiments.

FIG. 2 illustrates a schematic view of a method for arranging transport between parties, according to some embodiments.

FIG. 3 illustrates a mobile device as used for arranging transport between parties, according to some embodiments.

FIG. 4 illustrates a server used for arranging transport between parties, according to some embodiments.

FIG. 5 illustrates a flow chart in a method for arranging transport between parties, according to some embodiments.

FIG. 6 illustrates a flow chart in a method for arranging transport between parties, according to some embodiments.

FIG. 7 illustrates a flow chart in a method for arranging transport between parties, according to some embodiments.

FIG. 8 illustrates a flow chart in a method for registering users in a system for arranging transport between parties, according to some embodiments.

FIG. 9 is a block diagram illustrating an exemplary computer system 900 with which mobile devices 105, 135, 300 and server 101 of FIGS. 1A, 3, and 4 can be implemented.

Elements in the figures having the same or similar reference numerals are related to the same or similar features or steps, unless stated differently in the detailed description.

### DETAILED DESCRIPTION

Embodiments described herein are generally related to systems and methods for arranging transport among parties by mobile devices. More particularly, embodiments disclosed herein are related to arranging non-emergency medical transportation for people to and from a residence area, a nursing home, a hospital, clinic, pharmacy, or other temporary location. For example, embodiments of the present disclosure may be used by hospital patients that are discharged from a hospital and desire to go back to their home, or to a nursing home. In some embodiments, systems and methods consistent with the present disclosure may be used by patients who desire to go to a clinic for a routine treatment procedure. Some embodiments use mobile devices that can be precisely tracked down using geo-location hardware and software to provide a fast and efficient transportation service to users. Accordingly, some embodiments use Global Positioning System (GPS) hardware and software included in state-of-the-art mobile devices such as smart phones, tablet computers, palm computers, laptop computers, and hybrid devices combining any of the above configurations. Embodiments consistent with the present disclosure use a distributed network of mobile responders to answer a transportation request by a user. A centralized system assigns a transportation task to a responder accessibly located, relative to the requesting user. Accordingly, embodiments as disclosed herein include a server device in the centralized system that computes likely routes between a potential responder and a user, considering factors such as time of day and expected traffic. Based on the detailed information of the route from the responder to the user and to the requested drop-off location, and for traffic conditions, a more accurate fee calculation is possible.

In embodiments consistent with the present disclosure the user may be an elderly or disabled person. Moreover, the user may be temporarily disabled due to a medical condition. While the requested transportation may not be an emergency situation, it may be desirable to provide adequately adapted vehicles for the comfort and safety of the passenger. For example, some embodiments may use networks of responders including vehicles with wheelchair access capabilities. More generally, the responders include vehicles such as handicap accessible vans. In some embodiments, a health insurance company may provide the funds to cover the cost of transportation. In that regard, embodiments as disclosed herein include a request for verification of a user's healthcare insurance credentials to authorize selecting a responder to the user's transportation request. Accordingly, embodiments as described herein provide an advantageous transportation solution for permanently or temporarily disabled people by dramatically reducing wait time in the transportation process.

Some embodiments include the ability for the user and the selected responder to track each other's route and status before pickup. This allows the user to make a more efficient use of waiting time. According to some embodiments, the user and the responder may provide feedback about the transportation experience. The user feedback and the responder feedback may be stored in a ratings database. Data in the ratings database may be used by the server in the centralized system to evaluate the performance of a responder, and also to have a global perspective of the business strategy. For example, in some embodiments the server may rank users, times of day, and routes as more or less profitable according to an efficiency measure. Accordingly, the server may incorporate such ranking in a fee calculation to more efficiently incorporate true costs of transportation.

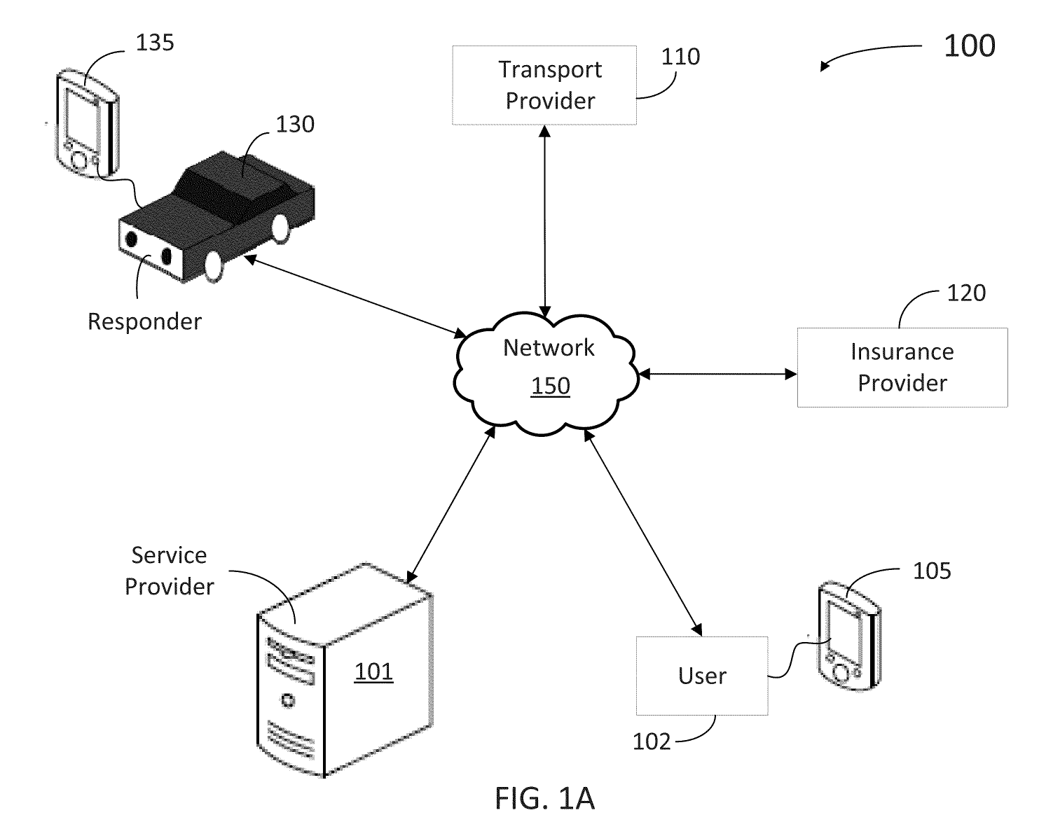

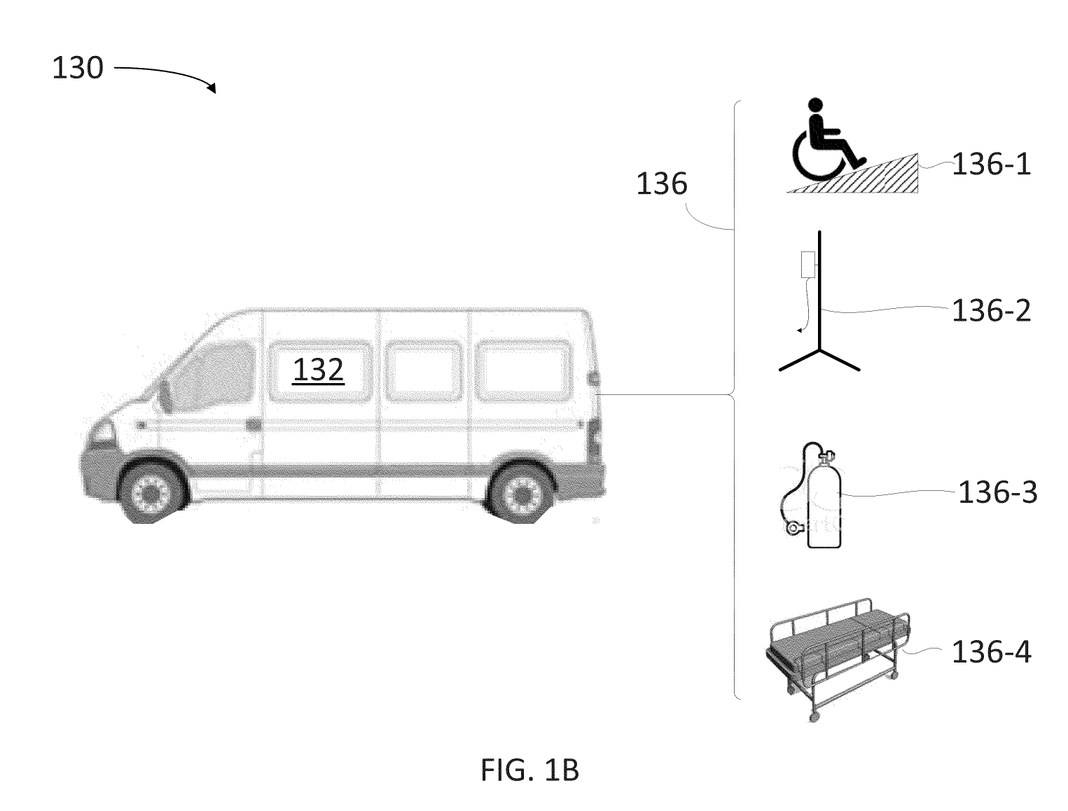

FIG. 1A illustrates a system 100 for arranging transport between parties, according to some embodiments. System 100 includes a service provider 101, a user 102 having a user mobile device 105, a transport provider 110, an insurance provider 120, and a responder 130 having a responder mobile device 135. Responder 130 may be one of a plurality of vehicles equipped for non-emergency medical transport, such as handicap accessible vans. In that regard, responder 130 may include a vehicle having an electronic escalator, or a ramp with a lift, for wheelchair accessibility. Service provider 101 communicates with transport provider 110 through a network 150. Likewise, transport provider 110 communicates with insurance provider 120 through network 150. And user 102 uses mobile device 105 to communicate with responder 130 using mobile device 135, through network 150. In that regard, network 150 may include a local area network (LAN), a wide area network (WAN), a wireless network, a fiber-optic based network, or any combination of the above.

User 102 requests a transportation service through user mobile device 105. Accordingly, user 102 may request the transportation service for him/her-self, or for a third party. For example, user 102 may request the transportation service for an elderly or disabled patient under the user's care. User 102 may be a registered user having an account with service provider 101, thus user 102 may access its account in service provider 101 to make a transportation request. For example, user 102 may include authorized personnel in a hospital, or a nursing home, such as a care giver, or a nurse. In some embodiments, user 102 may be a relative of the person or persons that will be transported by responder 130. The request is transferred from service provider 101 to transport provider 110. Accordingly, the request may include personal information about user 102, such as a healthcare insurance provider with authorization credentials. In some embodiments, user 102 may include in the transportation request healthcare insurance credentials of a third party for which user 102 is making the transportation request. Using the healthcare insurance credentials, transport provider 110 requests insurance provider 120 to verify (i.e., determine the presence, absence, or partial or total accuracy or completeness of) the credentials. In some embodiments, transport provider 110 may be a contractor hired by insurance provider 120. In which case user 102 may be an insured patient making a transportation request through insurance provider 120. Or insurance provider 120 may refer an insured patient to either service provider 101 or transport provider 110. In these cases, insurance verification for user 102 is automatic, since user 102 is an insured patient and the referral is made by insurance provider 120.

When insurance provider 120 authorizes the transport, transport provider 110 may select a responder 130 that is more conveniently located to arrive to user 102, for pickup. In that regard, transport provider 110 may select responder 130 based not only on distance to user 102, but also on traffic conditions and estimated time of arrival for pickup. Furthermore, transport provider 110 may select responder 130 based also on the availability of responder 130 for the transport service at the requested time. Moreover, transport provider 110 may select responder 130 based on the equipment in the vehicle of responder 130 and medical conditions of user 102. Once responder 130 has accepted the transport request, it may communicate directly with user 102 via network 150 and responder mobile device 135.

FIG. 1B illustrates a vehicle 132 used by responder 130 in system 100 (cf. FIG. 1A), according to some embodiments. Accordingly, vehicle 132 may include accessories 136 adapted for emergency and non-emergency transportation. Accessories 136 may include, without limitation, a wheelchair ramp 136-1, an intravenous unit 136-2, an oxygen tank 136-3, or a gurney 136-4. In some embodiments, vehicle 132 includes features adaptable to carry any one of the above mentioned accessories 136, or any other type of medical device that user 102 may desire during transportation.

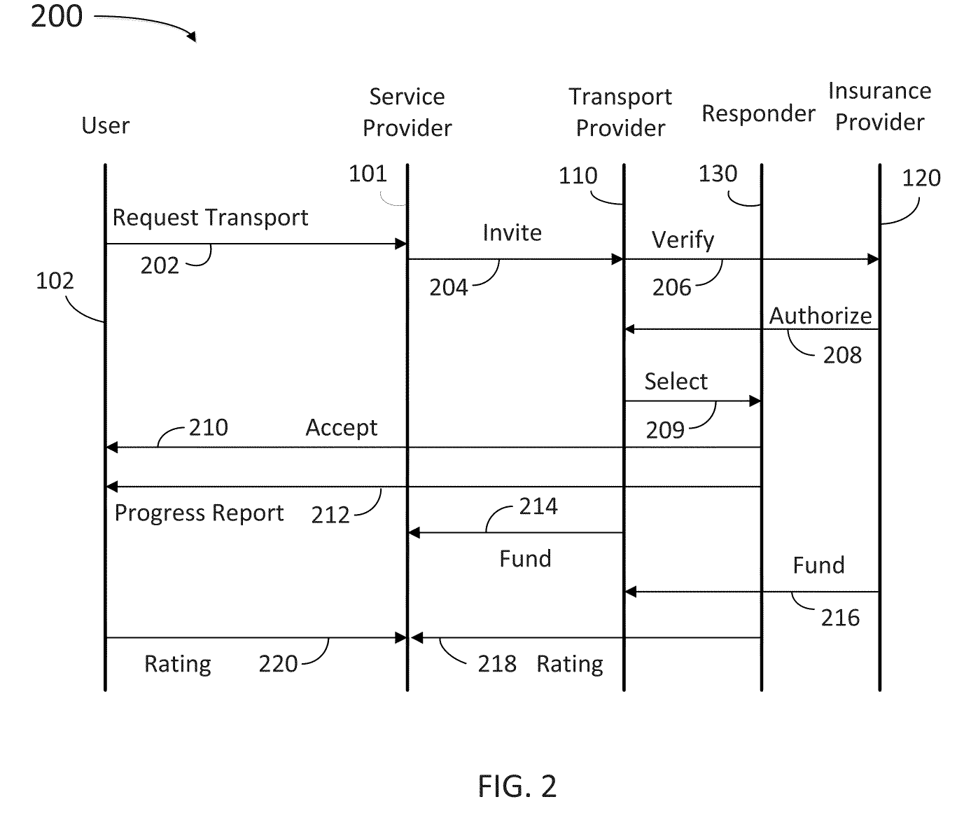

FIG. 2 illustrates a schematic view of a method 200 for arranging transport between parties, according to some embodiments. User 102 requests a transport 202. In response to request 202, service provider 101 sends an invitation 204 to transport provider 110 for a bid to provide the transport requested by user 102. Transport provider 110 also sends a verification request 206 to insurance provider 120, including personal information about user 102. In some embodiments, verification request 206 may include an estimate of the cost of transportation (fee) and healthcare insurance credentials for user 102. Insurance provider 120 determines eligibility of user 102 to participate in the transportation process based on the user's insurance policy and on the estimated cost. Accordingly, transport provider 110 may be able to compute a cost of transportation by knowing the location of user 102, and the point of destination. Moreover, in some embodiments the cost of transportation may include the location of responder 130, and even traffic conditions in the areas including an estimated route for responder 130 to user 102, and to the final destination.

Insurance provider 120 verifies its records and provides an authorization 208 for transport provider 110 to proceed and provide the transportation service to user 102. Accordingly, transport provider 110 makes a selection 209 of a responder 130 from a plurality of responders that may be in an area near user 102, or otherwise available to provide transportation. Moreover, in some embodiments selection 209 is made based on responder 130 being controlled by a service provider 110 under contract by insurance provider 120. The selected responder 130 within the network of transport provider 110 sends an acceptance notification 210 to user 102. As responder 130 approaches user 102, a progress report 212 is communicated to user 102. When the transportation process is complete or at any time of the process even before acceptance 210, transport provider 110 transfers funds 214 to service provider 101. In some embodiments, funds transfer 214 from transport provider 110 to service provider 101 may occur when transport provider 110 provides selection 209. In some embodiments, funds transfer 214 may occur when insurance provider 120 provides authorization 208 to transport provider 110 to proceed with the transport process. Funds transfer 214 may be executed by service provider 101 electronically accessing a bank account or credit card information of transport provider 110, according to an agreement between service provider 101 and transport provider 110. Furthermore, service provider 101 may send an e-mail or a text message, or any other type of electronic confirmation to transport provider 110 that a charge has been made by fund transfer 214.

When the transportation process is complete or at any time of the process after acceptance 210, insurance provider 120 transfers funds 216 to transport provider 110. When the transportation process is complete, user 102 provides a rating 220 of the transportation service to service provider 101. Likewise, when the transportation process is complete responder 130 provides a rating 218 of the transportation process to service provider 101. It will be apparent to those of ordinary skill that in a system and method as disclosed herein, transport provider 110 and service provider 101 may be part of a single entity. Moreover, in some embodiments service provider 101 may be coupled to a plurality of transport providers 110, including for example at least one transport provider entity that is controlled by service provider 101. More generally, transport provider 110 may include a plurality of independent entities, each having a set of responders 130 and competing to have access to the users of service provider 101. A system and method for arranging transport among parties as disclosed herein offers the advantage of placing a plurality of transport providers 110 in competition for having more responders 130 available through specific areas, so as to increase market share in those areas. This in turn has the effect of lowering service costs, and of reducing waiting time for user 102. Accordingly, this will have the effect of an increased client base for the service.

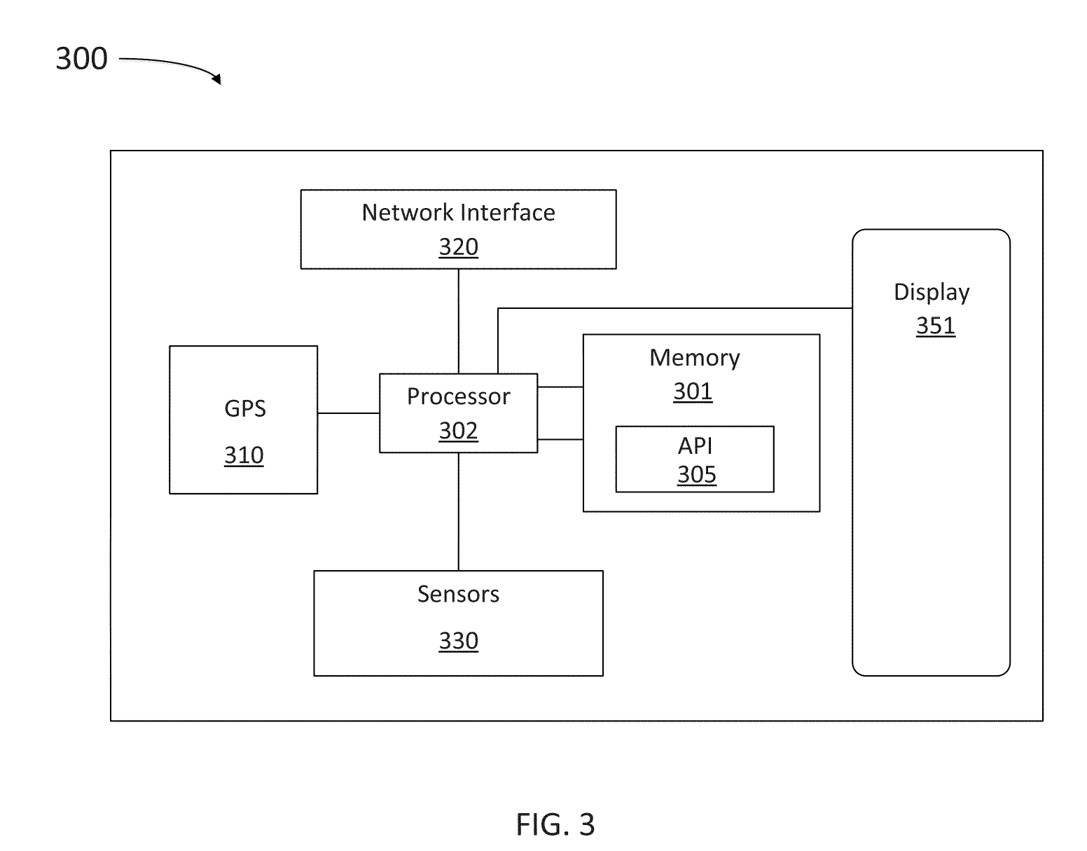

FIG. 3 illustrates a mobile device 300 as used for arranging transport between parties, according to some embodiments. More specifically, mobile device 300 may be a wireless computing device that communicates with a network (e.g., network 150, cf. FIG. 1). Mobile device 300 may be as user mobile device 105 or responder mobile device 135. A memory 301 stores commands which, when executed by a processor 302 cause mobile device 300 to perform steps in methods consistent with the present disclosure. Accordingly, an application programming interface (API) 305 installed in memory 301 may include at least some of the commands which, when executed by processor 302 cause mobile device 300 to perform a method for non-emergency medical transportation of a patient, as disclosed herein. A network interface circuit 320 transmits and receives information between mobile device 300 and network 150. Accordingly, network interface circuit 320 may include one or more antennas, filters, and signal processing circuitry. In that regard, network interface circuitry 320 includes wireless electronic circuitry. Mobile device 300 includes a plurality of sensors 330 providing data for tracking mobile device 300. For example, sensors 330 may include an accelerometer that provides an acceleration value as a function of time. With this information, transport provider 110 or service provider 101 may be able to precisely track the location of mobile device 300, its speed, and an estimated time of arrival to a destination. Mobile device 300 includes Global Positioning Satellite (GPS) circuit 310 for geo-coordinate location of mobile device 300.

Mobile device 300 includes a display 351 to provide the progress report to the user, the responder, or both. Accordingly, display 351 displays a map indicating a current user location and a current responder location in the progress report. The progress report may be generated by service provider and transmitted to user 102 and to responder 130. In some embodiments the progress report may be provided by responder mobile device 135. In some embodiments, user 102 is a care giver or a nurse arranging transportation for a plurality of patients in a health care facility. In such embodiments, mobile device 105 may include a database in memory 301 with a plurality of patients that may desire to be transported into or out of the healthcare facility. Accordingly, API 305 is configured to access the database having a list of patients, so that user 102 may select any one of the plurality of patients for arranging transportation.

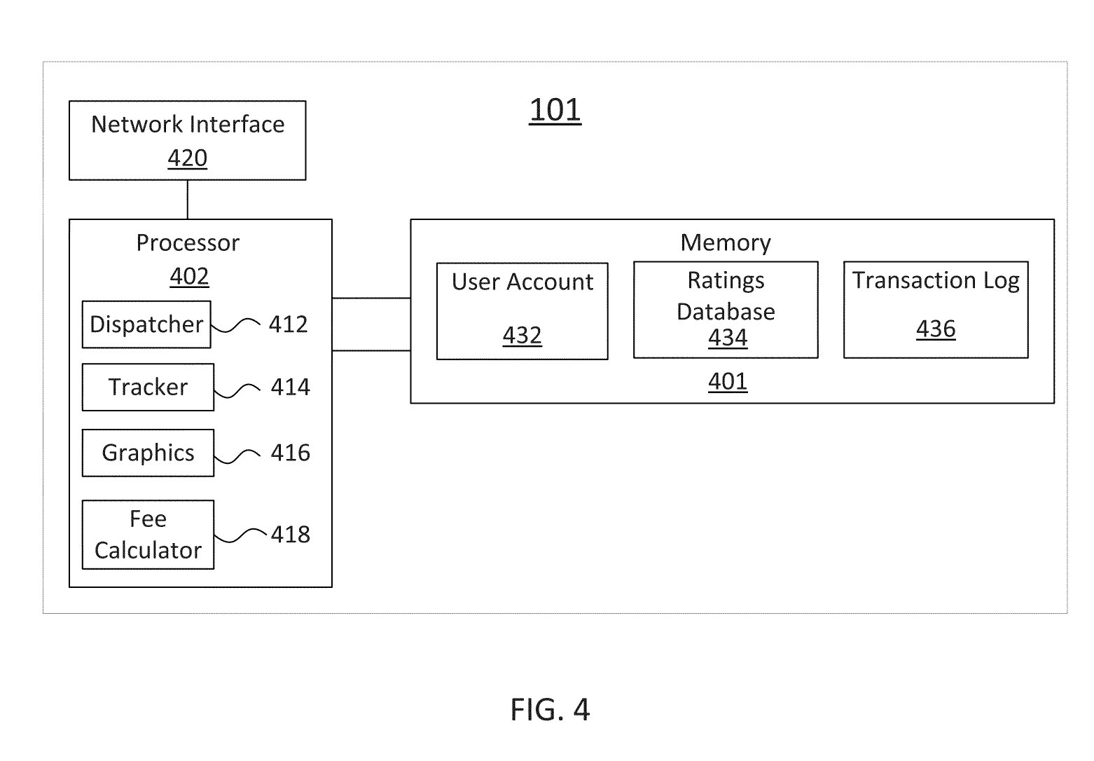

FIG. 4 illustrates a server 101 used for arranging transport between parties, according to some embodiments. Server 101 includes a memory 401, a processor 402, and a network interface 420. Memory 401 may be any type of non-transitory computer readable medium as known to one of ordinary skill. For example, memory 401 may include a compact disc (CD), a digital video disc (DVD), a magnetic tape, a flash drive, or similar. Memory 401 stores commands which, when executed by processor 402, cause server 101 to at least partially perform steps in methods consistent with the present disclosure. Memory 401 may include a user account 432, a ratings database 434, and a transaction log 436. In some embodiments, any one or all of user account 432, ratings data base 434, and transaction log 436 may be included in a database server external to server 101. Ratings database 434 stores rating information for the user and for the responder. In some embodiments, ratings database 434 may include historical information for each of the user and the responder. In that regard, ratings database 434 may include tables for each of a plurality of users and for each of a plurality of responders. Processor 402 includes a dispatcher 412, a tracker 414, graphics circuitry 416, and a fee calculator 418. Fee calculator 418 may find the fee to charge to the user based on the time and distance involved. In some embodiments, the fee calculator establishes a flat fee for each of the medical and transportation services provided. Dispatcher 412 may receive the transport request from the user and broadcast the transport request to a plurality of responders. Tracker 414 accesses the GPS circuit in a mobile device, to retrieve geo-coordinate information. Tracker 414 also correlates the geo-coordinates of a user mobile device or a responder mobile device to a map for a graphic display. The map may include a street map having geo-located features. Software associated to GPS circuit 310 may be stored as commands in memory 301.

Processor 402 may register events during the transportation process in transaction log 436. Transaction log 436 may be analyzed by processor 402 to perform statistical analysis and elaborate a business strategy. Data that may be used for this purpose and stored in transaction log may include the total time to completion of the transport process, the route followed, the time of day, and other information related to user 102 and to responder 130.

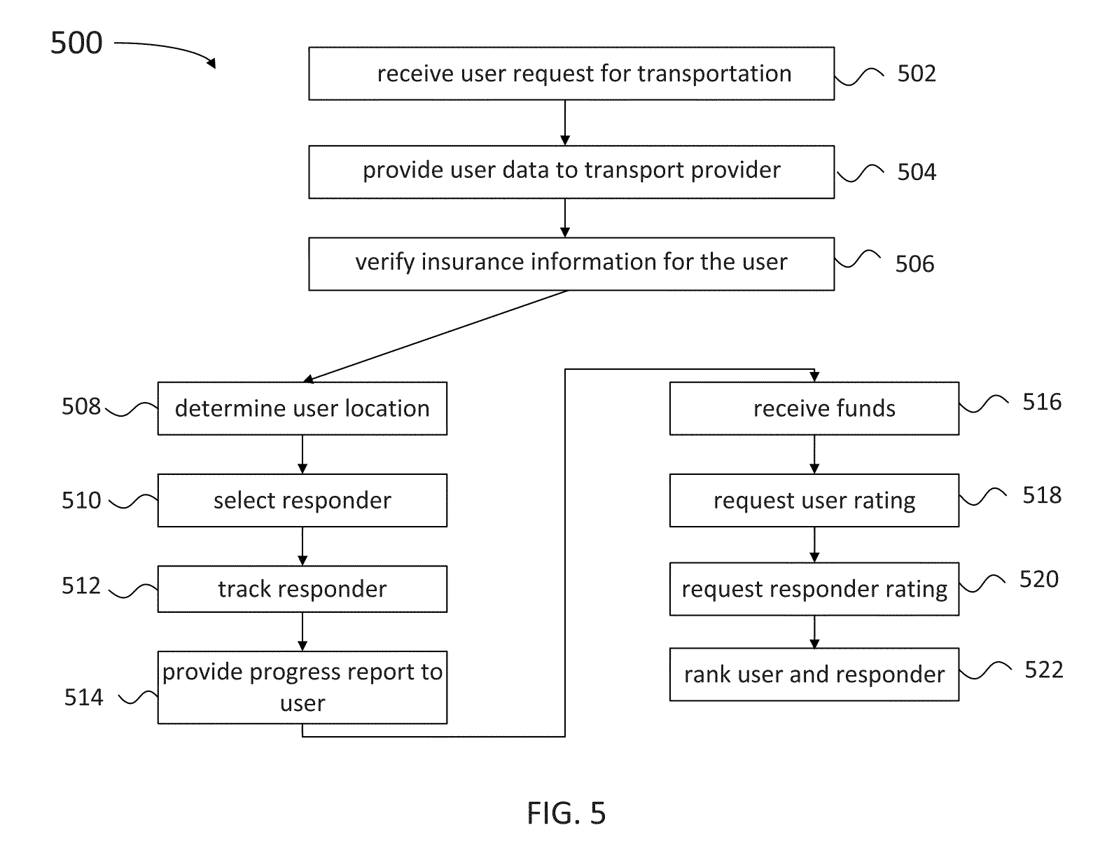

FIG. 5 illustrates a flow chart in a method 500 for arranging transport between parties, according to some embodiments. In some embodiments, method 500 may be performed in connection with a system including a service provider, a user having a user mobile device, a transport provider, an insurance provider, and a responder having a responder mobile device (e.g., system 100, cf. FIG. 1). Communication steps including transmitting and receiving information may be carried out through a network that may include a local area network (LAN), a wide area network (WAN), a wireless network, a fiber-optic based network, or any combination of the above (e.g., network 150, FIG. 1).

Steps in method 500 may be performed at least partially by a server coupled to a network, the server including a memory, a processor, and a network interface (e.g., server 101, memory 401, and processor 402, cf. FIG. 4). The memory stores commands which, when executed by the processor, cause the server to at least partially perform steps in methods consistent with the present disclosure. The memory may include a user account, a ratings database, and a transaction log (e.g., user account 432, ratings database 434, and transaction log 436, cf. FIG. 4). Moreover, steps in method 500 may also be performed in combination with a user mobile device and a responder mobile device that have an API that enables the server to communicate with the user mobile device and the responder mobile device. Accordingly, in some embodiments, personnel in hospitals, clinics, and nursing homes may download the API from the server so that the request for transportation may be processed as described in FIG. 5.

Methods consistent with the present disclosure may include some but not all of the steps illustrated in FIG. 5. Furthermore, methods consistent with method 500 may include steps other than those illustrated in FIG. 5. Moreover, methods consistent with the present disclosure may include one or more steps as illustrated in FIG. 5 performed in any order, or overlapping in time. In some embodiments, some steps illustrated in FIG. 5 may be performed simultaneously, or almost simultaneously.

Step 502 includes receiving a user request for transportation. Accordingly, the user request may be transmitted to the server via the user mobile device and the network. The user may be a registered user for the server, so that step 502 may include providing, by the user, login credentials into a server account. More specifically, step 502 may include providing to a user mobile device and to a responder mobile device an API that allows the server to perform the steps in method 500 by communicating with the user and the responder. Step 504 includes providing user data to the transport provider. Accordingly, the user data may include healthcare insurance credentials for the user, or for a third party associated with the user. Step 506 includes verifying insurance information for the user. Accordingly, step 506 may include presenting the user healthcare insurance credentials to the insurance provider, through the network. In some embodiments, step 506 includes the service provider communicating directly with the insurance provider on behalf of the transport provider. For example, step 506 may include the service provider transmitting a message to the insurance provider such as: “Transportation provider X wants to offer user Y a non-emergency transport service from point A to point B, related to claim C, with a total estimated cost of Z.”

Step 508 includes determining a user location. Step 508 may include explicitly requesting the user for permission to track the user location using a tracker circuit in the server. When the user authorizes the server to track its location, the server may access GPS data collected from a GPS circuit in the user mobile device. Furthermore, the server may correlate the GPS data from the user mobile device with a street map, or a geographic map. Step 510 includes selecting a responder from a plurality of responders controlled by the transport provider. Accordingly, step 510 may include selecting a responder located close to the user. For example, in some embodiments step 510 includes selecting the closest responder to the user. Further according to some embodiments, step 510 includes selecting a responder based on a ratings database. For example, in some embodiments the server may rank the responders according to user feedback provided in past transportation events associated with each responder. The user feedback may be stored in a ratings database of the server. Accordingly, the ratings database may also include a responder rating. In some embodiments, step 510 includes sending a request for transportation to all responders within a certain radius of the user, or to a responder that has a vehicle with the medical capabilities requested by the user. Further according to some embodiments, step 510 includes providing the user a list of potential responders and their rates, and the locations where they are. Furthermore, step 510 may include receiving a user selection of a specific responder based on the rate of the responder, its location, or whether or not the responder has the vehicle capabilities used in the transportation. Further according to some embodiments, step 510 may include establishing the same rates for every vendor in system 100.

Step 512 includes tracking the responder. Accordingly, step 512 may include explicitly requesting the responder for permission to track the responder location using a tracker circuit in the server. When the responder authorizes the server to track its location, the server may access GPS data collected from a GPS circuit in the responder mobile device. Step 514 includes providing a progress report to the user. In some embodiments, step 514 may include providing text messages directly to the user mobile device from the responder mobile device. Moreover, in some embodiments step 514 may include providing the user mobile device access to a graphic representation indicating a map with a visible feature for the user location and a visible feature for the responder location. Step 516 includes receiving funds. In some embodiments, funds are received from the transport provider. In some embodiments, funds may be received from the insurance provider. In yet other embodiments, the funds may be provided by the user. For example, in embodiments where the user has no health insurance credentials, funds may me directly provided by the user to the service provider in step 516. Step 518 includes requesting a user rating. Step 520 includes requesting a responder rating. In some embodiments, steps 518 and 520 include storing the user rating and the responder rating in the ratings database. And step 522 includes ranking the user and the responder.

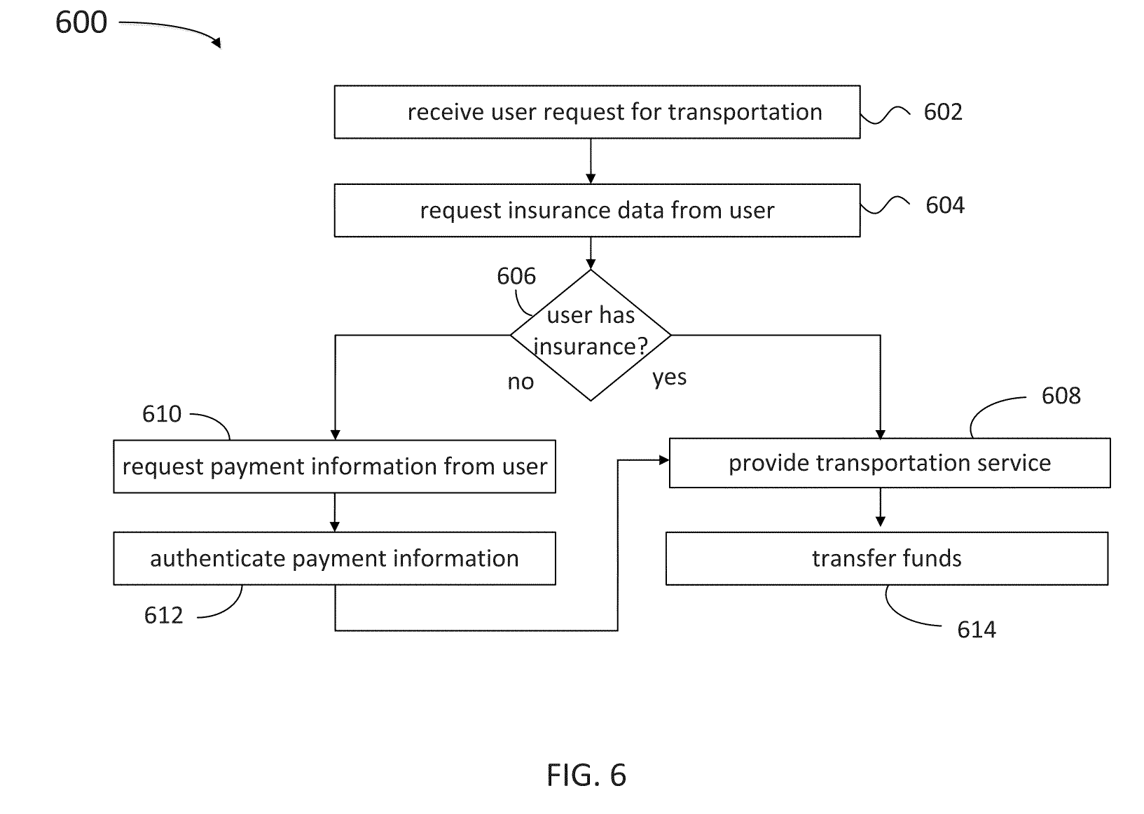

FIG. 6 illustrates a flow chart in a method 600 for arranging transport between parties, according to some embodiments. In some embodiments, method 600 may be performed in connection with a system including a service provider, a user having a user mobile device, a transport provider, an insurance provider, and a responder having a responder mobile device (e.g., system 100, cf. FIG. 1). Communication steps including transmitting and receiving information may be carried out through a network that may include a local area network (LAN), a wide area network (WAN), a wireless network, a fiber-optic based network, or any combination of the above (e.g., network 150, FIG. 1).

Steps in method 600 may be performed at least partially by a server coupled to a network, the server including a memory, a processor, and a network interface (e.g., server 101, memory 401, and processor 402, cf. FIG. 4). The memory stores commands which, when executed by the processor, cause the server to at least partially perform steps in methods consistent with the present disclosure. The memory may include a user account, a ratings database, and a transaction log (e.g., user account 432, ratings database 434, and transaction log 436, cf. FIG. 4).

Methods consistent with the present disclosure may include some but not all of the steps illustrated in FIG. 6. Furthermore, embodiments consistent with method 600 may include steps other than those illustrated in FIG. 6. Moreover, methods consistent with the present disclosure may include one or more steps as illustrated in FIG. 6 performed in any order, or overlapping in time. In some embodiments, some steps illustrated in FIG. 6 may be performed simultaneously, or almost simultaneously.

Step 602 includes receiving a user request for transportation. In that regard, step 602 may be as described in detail above with respect to step 502 in method 500. Step 604 includes requesting insurance data from the user. Accordingly, step 604 may include a request for the user to enter medical insurance information such as insurance provider identification, an account identification, and other healthcare insurance credentials. Step 606 includes determining whether the user has health insurance.

Step 608 includes providing a transportation service to the user. In some embodiments, step 608 is performed when it is determined in step 606 that the user has insurance. Accordingly, step 608 may include performing all or at least some of the steps in method 500 described in detail above (cf. FIG. 5).

Step 610 includes requesting payment information from the user when it is determined in step 606 that the user has no healthcare insurance to cover for the costs of transportation. Step 610 may include requesting a bank account number, or a credit card number and information from the user, in order to process a fund transfer. Step 612 includes authenticating the payment information. Accordingly, step 612 may include communicating with a server handling user's funds to verify that funds for the transaction are available. When the payment information is authenticated, method 600 includes providing the transportation service to the user in step 608 (described in detail above). In some embodiments, the information collected by the server in steps 610 and 612 may be transparent (or invisible) to the server, and the server relays the information directly to a transport provider server. In that regard, even when the user pays an out-of-pocket fee, the server arranging for the transport receives the funds from the transport provider. This configuration adds to the simplicity and convenience of a method for arranging transport as disclosed herein. In some embodiments, in steps 610 and 612 the server may relay the user information to a third party server handling funding accounts for the user.

Step 614 includes transferring funds to at least partially cover a transportation fee into an account set by the service provider. Accordingly, step 614 may include transferring funds from the transportation provider or the insurance provider, when the user has insurance.

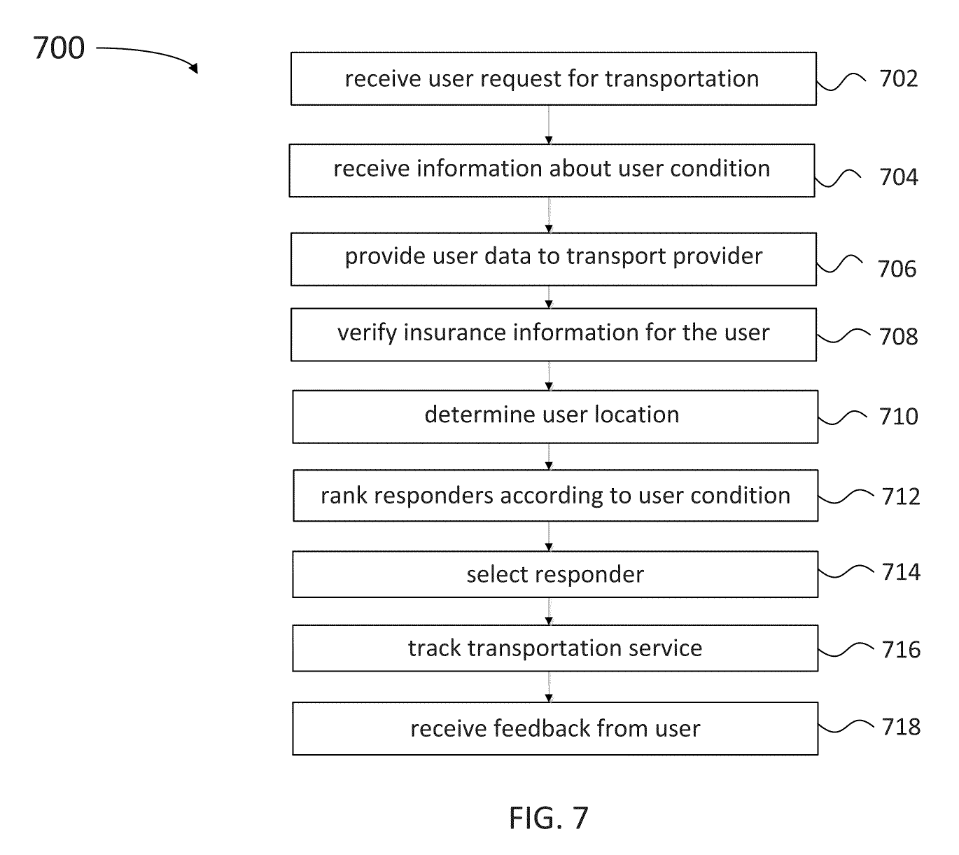

FIG. 7 illustrates a flow chart in a method 700 for arranging transport between parties, according to some embodiments. In some embodiments, method 700 may be performed in connection with a system including a service provider, a user having a user mobile device, a transport provider, an insurance provider, and a responder having a responder mobile device (e.g., system 100, cf. FIG. 1). Communication steps including transmitting and receiving information may be carried out through a network that may include a local area network (LAN), a wide area network (WAN), a wireless network, a fiber-optic based network, or any combination of the above (e.g., network 150, FIG. 1).

Steps in method 700 may be performed at least partially by a server coupled to a network, the server including a memory, a processor, and a network interface (e.g., server 101, memory 401, and processor 402, cf. FIG. 4). The memory stores commands which, when executed by the processor, cause the server to at least partially perform steps in methods consistent with the present disclosure. The memory may include a user account, a ratings database, and a transaction log (e.g., user account 432, ratings database 434, and transaction log 436, cf. FIG. 4).

Methods consistent with the present disclosure may include some but not all of the steps illustrated in FIG. 7. Furthermore, embodiments consistent with method 700 may include steps other than those illustrated in FIG. 7. Moreover, methods consistent with the present disclosure may include one or more steps as illustrated in FIG. 7 performed in any order, or overlapping in time. In some embodiments, some steps illustrated in FIG. 7 may be performed simultaneously, or almost simultaneously.

Step 702 includes receiving a user request for transportation. Step 704 includes receiving information about the user medical condition. Accordingly, step 704 may include receiving information such as user's age, diagnostic information, whether or not the user is ambulatory or bed ridden, whether or not the user is in a wheelchair, whether the user carries or desires an intravenous unit in the transport vehicle, or whether or not the user is able to communicate with the responder. Step 704 may also include receiving information such as whether the user has arthritis, is paraplegic, the user has osteoporosis, or has any other physical ailment that may require a specially conditioned vehicle for transportation. In some embodiments, information about the user medical condition may include the user's chief complaint at the moment of the request for transportation, or the reason why the user desires to go to a healthcare facility. In some embodiments, step 704 includes indicating to the user that providing the user medical condition is voluntary. Further according to some embodiments, step 704 includes receiving information about the user medical condition from a care giver who is responsible for the user and who is requesting the transportation.

Step 706 includes providing the user data to a transport provider. Step 708 includes verifying insurance information for the user. Step 710 includes determining the user location. Step 712 includes ranking responders according to the user condition. Accordingly, step 712 may include using a linear equation to determine a ranking value, rⱼ, for a responder ‘j’, as follows:

$${r}_{j} = {\sum }_{i = 1}^{n} {a}_{i} \cdot {b}_{ij} \qquad ( 1 )$$

Where the coefficients ‘aᵢ’ indicate a weighting factor and the coefficients ‘bᵢ’ indicate a parameter value. Weighting factors ‘ai’ may be numbers between 0 and 1, selected according to a model based on historic data and feedback provided by users and responders. Parameter value ‘bij’ may be selected from a plurality of parameter values such as: distance of responder ‘j’ to user, matching of a vehicle medical feature or medical accessory with the user requirements, or an estimated response time to the user, based on the location of responder ‘j’ and on user location. In some embodiments, parameter ‘bij’ may indicate whether responder ‘j’ has a contract or accepts transactions with the insurance provider associated with the user. Step 714 includes selecting a responder. Step 716 includes tracking transportation service to the user. And step 718 includes receiving feedback from the user.

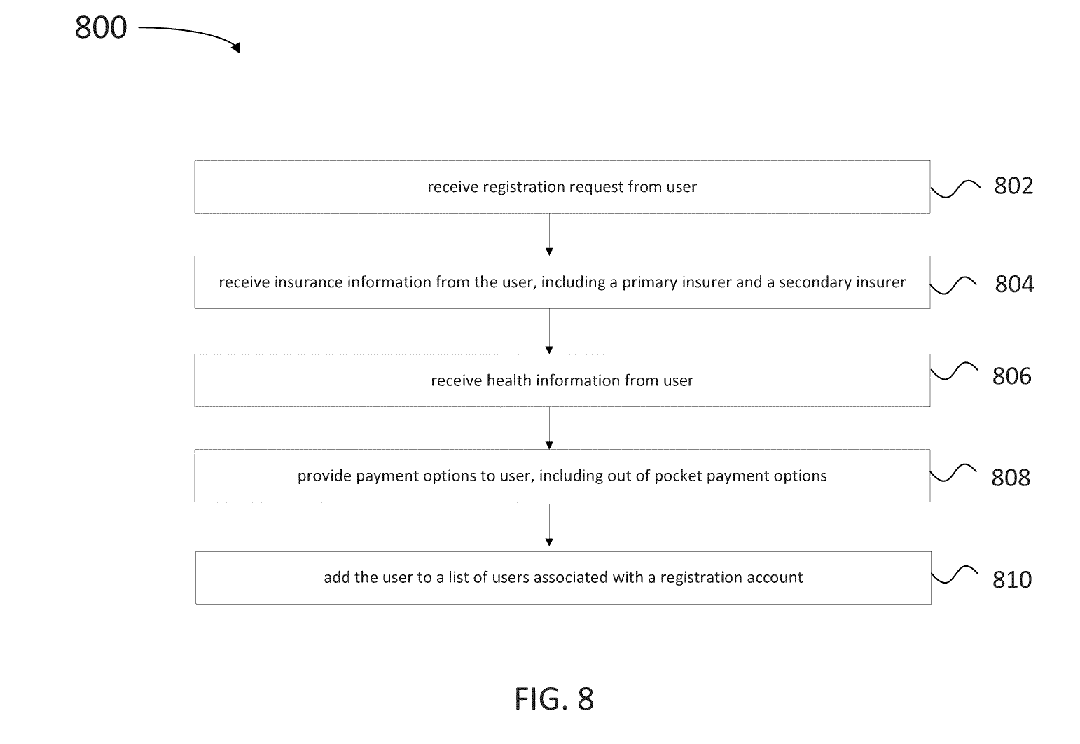

FIG. 8 illustrates a flow chart in a method 800 for registering users in a system for arranging transport between parties, according to some embodiments. In some embodiments, method 800 may be performed in connection with a system including a service provider, a user having a user mobile device, a transport provider, an insurance provider, and a responder having a responder mobile device (e.g., system 100, cf. FIG. 1). Communication steps in method 800 including transmitting and receiving information may be carried out through a network that may include a local area network (LAN), a wide area network (WAN), a wireless network, a fiber-optic based network, or any combination of the above (e.g., network 150, FIG. 1).

Steps in method 800 may be performed at least partially by a server coupled to a network, the server including a memory, a processor, and a network interface (e.g., server 101, memory 401, and processor 402, cf. FIG. 4). The memory stores commands which, when executed by the processor, cause the server to at least partially perform steps in methods consistent with the present disclosure. The memory may include a user account, a ratings database, and a transaction log (e.g., user account 432, ratings database 434, and transaction log 436, cf. FIG. 4).

Methods consistent with the present disclosure may include some but not all of the steps illustrated in FIG. 8. Furthermore, embodiments consistent with method 800 may include steps other than those illustrated in FIG. 8. Moreover, methods consistent with the present disclosure may include one or more steps as illustrated in FIG. 8 performed in any order, or overlapping in time. In some embodiments, some steps illustrated in FIG. 8 may be performed simultaneously, or almost simultaneously.

Step 802 includes receiving a registration request from the user. Step 804 includes receiving insurance information from the user, including a primary insurer and a secondary insurer. The secondary insurer enters into effect in case that the primary insurance rejects payment for the service. Step 806 includes receiving health information from the user. Accordingly, step 806 may include receiving information such as user's age, diagnostic information, whether or not the user is ambulatory or bed ridden, whether or not the user is in a wheelchair, whether the user carries or desires an intravenous unit in the transport vehicle, or whether or not the user is able to communicate with the responder. Step 806 may also include receiving information such as whether the user has arthritis, is paraplegic, the user has osteoporosis, or has any other physical ailment that may require a specially conditioned vehicle for transportation. Step 808 includes providing payment options to the user, including out of pocket payment options. For example, in some embodiments step 808 includes providing credit card payment options to the user, or an online payment system using a mobile device and a private account in a remote server providing financial services to the user. In some embodiments, step 808 includes providing a default out-of-pocket payment option to the user. In that regard, the user may be refunded for the expenses by the insurance provider at a later time. Furthermore, in some embodiments step 808 includes an option for the user to accept the charges for the transportation fee even when an insurance verification is not authorized, or the user has no insurance.

Step 810 includes adding the user to a list of users associated with a registration account with the server. Accordingly, the registration account may be associated with a nurse or care giver in a healthcare facility or nursing home, and the user may be one of a plurality of patients in the healthcare facility or nursing home.

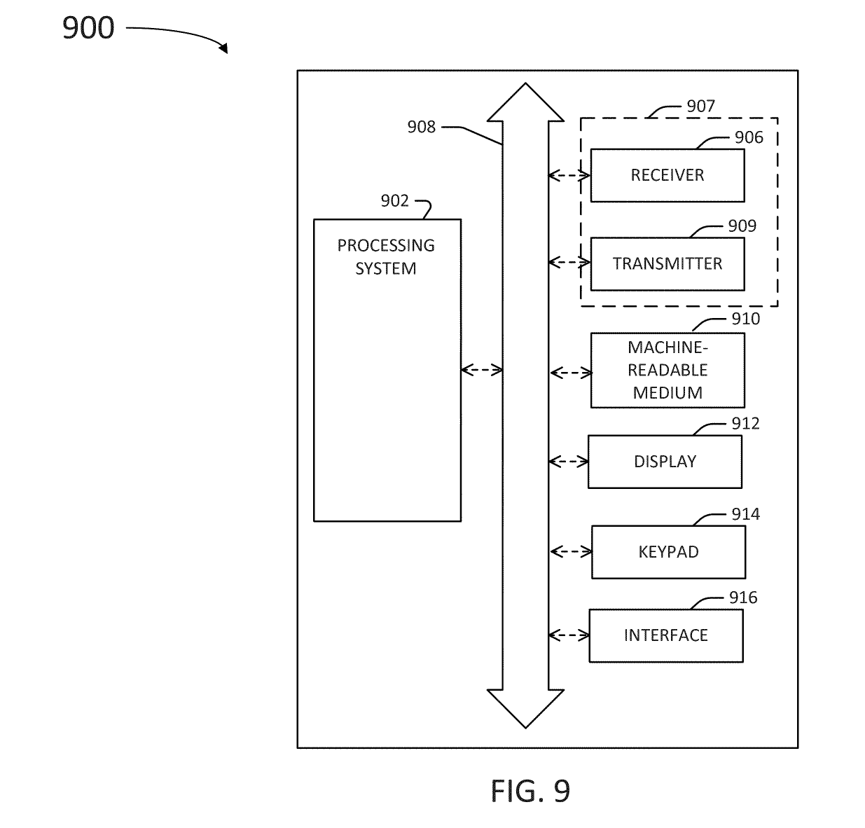

FIG. 9 is a block diagram illustrating an exemplary computer system 900 with which mobile devices 105, 135, 300 and server 101 of FIGS. 1A, 3, and 4 can be implemented. In certain aspects, the computer system 900 may be implemented using hardware or a combination of software and hardware, either in a dedicated server, or integrated into another entity, or distributed across multiple entities.

Computer system 900 (e.g., mobile devices 105, 135, 300, and server 101) includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. Also coupled to bus 908, computer system 900 includes a network communication circuit 907 having a receiver 906 and a transmitter 909, a display 912, a keypad 914, and an interface 916.

Computer system 900 can include, in addition to hardware, code that creates an execution environment for the computer program in question, e.g., code that constitutes processor firmware, a protocol stack, a database management system, an operating system, or a combination of one or more of them stored in an included memory or machine readable medium 910, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 910 and implemented in one or more computer program products, i.e., one or more modules of computer program instructions encoded on a computer readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

According to one aspect of the present disclosure, mobile devices 105, 135 and 300 and server 101 can be implemented using a computer system 900 in response to processor 902 executing one or more sequences of one or more instructions contained in memory 910. Such instructions may be read into memory 910 from another machine-readable medium, such as a data storage device. Execution of the sequences of instructions contained in memory 910 causes processor 902 to perform the process steps described herein. One or more processors in a multi-processing arrangement may also be employed to execute the sequences of instructions contained in memory 910. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network.

Computing system 900 can include clients and servers. A client and server are generally remote from each other and typically interact through a communication network. The relationship of client and server arises by virtue of computer programs running on the respective computers and having a client-server relationship to each other. Computer system 900 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While certain aspects and embodiments of the subject technology have been described, these have been presented by way of example only, and are not intended to limit the scope of the subject technology. Indeed, the novel methods and systems described herein may be embodied in a variety of other forms without departing from the spirit thereof. The accompanying claims and their equivalents are intended to cover such forms or modifications as would fall within the scope and spirit of the subject technology.

1. A system for providing transportation, comprising:
a network interface configured to receive a user request for transportation and to provide user data to a transport provider;
a dispatcher configured to provide the request for transportation to a plurality of responders;
a processor configured to receive insurance information about the user and, based on (i) the insurance information, (ii) a distance of a responder to the user, and (iii) a requirement of the user for a medical transportation capability, to select a responder from the plurality of responders;
a tracker circuit configured to determine a user location and a responder location;
a graphics circuit configured to provide a street map indicating a current user location and a current responder location to the user and to the responder; and
a memory coupled to:
a user account database comprising personal user information for a plurality of users;
a ratings database configured to store a user rating; and
a transaction log configured to store events in the transportation process.

2. The system of claim 1, wherein the processor is further configured to rank the user and the responder.

3. The system as in claim 1, wherein the network interface is further configured to provide a progress report to the user, the progress report including the street map provided by the graphics circuit.

4. The system as in claim 1, further comprising a fee calculator circuit to determine a fee to cover at least partially a cost of transportation, and wherein the network interface is further configured to provide the fee to at least one of a transport provider, an insurance provider, and the user.

5. The system as in claim 4, further configured to receive payment of at least a portion of the fee from the transport provider, conditional upon issuance of an authorization from the insurance provider.

6. The system as in claim 4, wherein the fee calculator is configured to provide a flat referral fee to the transport provider.

7. The system of claim 1, wherein the ratings database is further configured to store a responder rating.

8. The system of claim 1, wherein the ratings database stores historical information of each of the plurality of responders.

9. A method for arranging transport among parties by mobile devices, the method comprising:
receiving a user request for transportation via an application programming interface installed in a user mobile device;
providing a user data to a transport provider, the user data comprising healthcare insurance information for the user;
verifying the healthcare insurance information with an insurance provider;
determining a user location based on a global positioning system (GPS) circuit in the user mobile device;
based on (i) the insurance information, (ii) a distance of a responder to the user, and (iii) a requirement of the user for a medical transportation capability, selecting a preferred responder from a plurality of responders, the preferred responder having a handicap accessible vehicle for non-emergency transportation;
tracking the preferred responder via a GPS circuit in a responder mobile device;
requesting a user rating when the preferred responder has transported the user to a desired location; and
ranking the user and the preferred responder based at least on the user rating.

10. The method of claim 9, wherein selecting a preferred responder comprises sending a transport request signal to a responder located closest to the user.

11. The method of claim 9, wherein selecting a preferred responder comprises sending a transport request signal to a responder that is authorized by an insurance provider.

12. The method of claim 9, further comprising determining a fee for the transport.

13. The method of claim 12, further comprising providing the fee to the transport provider.

14. The method of claim 12, further comprising providing the fee to an insurance provider.

15. The method of claim 12, further comprising receiving a fund covering the fee at least partially, from the transport provider.

16. The method of claim 9, further comprising providing a list comprising a plurality of patients to the user, and receiving a selections from the user of a patient to be transported, from the plurality of patients.

17. The method of claim 9, wherein the verifying the healthcare insurance information comprises contacting a primary insurance provider, and a secondary insurance provider when the primary insurance provider refuses payment.

18. A non-transitory computer readable medium storing commands which, when executed by a processor circuit in a server cause the server to perform a method comprising:
receiving a user request for transportation via an application programming interface installed in a user mobile device;
providing user data to a transport provider, the user data comprising healthcare insurance information for the user;
verifying the healthcare insurance information with an insurance provider;
determining a user location based on a global positioning system (GPS) circuit in the user mobile device;
based on (i) the insurance information, (ii) a distance of a responder to the user, and (iii) a requirement of the user for a medical transportation capability, selecting a preferred responder from a plurality of responders, the responder having a handicap accessible vehicle for non-emergency transportation;
tracking the preferred responder via a GPS circuit in a responder mobile device;
requesting a user rating when the preferred responder has transported the user to a desired location; and
ranking the user and the responder based at least on the user rating.

19. The non-transitory computer readable medium of claim 18, wherein verifying the healthcare insurance information comprises receiving from the insurance provider an authorization to proceed with the transportation process for the user.

20. The non-transitory computer readable medium of claim 18, further comprising commands to cause the server to perform providing a progress report to the user indicating a location of the selected responder and an updated estimated time of arrival for pickup.
